(19) United States
(12) Patent Application Publication
(10) Pub. No.: US 2023/0183119 A1
(43) Pub. Date: Jun. 15, 2023

(54) PUDDLE FORMATION DEVICE

(71) Applicant: CORNING INCORPORATED, CORNING, NY (US)

(72) Inventors: TOMOHIRO ABURADA, PAINTED POST, NY (US); KAUSHIK ARUMBULIYUR COMANDUR, HARBORNE (GB)

(21) Appl. No.: 17/925,491

(22) PCT Filed: May 7, 2021
(86) PCT No.: PCT/US2021/031234

§ 371 Date: Nov. 15, 2022

Related U.S. Application Data
(60) Provisional application No. 63/026,266, filed on May 18, 2020.

(51) Int. Cl. C03B 17/06

(52) U.S. Cl. CPC C03B 17/06

(57) ABSTRACT

An apparatus and method for manufacturing a glass sheet are disclosed. The apparatus includes a glass delivery device, a puddle forming device positioned to contact and redirect at least a portion of a stream of molten glass as it falls from the glass delivery device, and a side roller configured to contact the stream falling from the glass delivery device and redirected from the puddle forming device at a target position and lose contact with the stream at a departure position to form a ribbon of glass. The puddle forming device and the side roller can be relatively positioned to form a puddle of molten glass on a surface of the side roller positioned upstream from the target position and a thickness control gap between the puddle forming device and the side roller.

### CROSS-REFERENCE TO RELATED APPLICATION

This application is a national stage entry of International Patent Application Serial No. PCT/US2021/031234, filed on May 7, 2021, which in turn, claims the benefit of priority under 35 U.S.C. § 119 of U.S. Provisional Application Ser. No. 63/026266, filed on May 18, 2020, the contents of each of which are relied upon and incorporated herein by reference in their entireties.

### BACKGROUND

The present disclosure relates to an apparatus and method for controlling the flow, temperature, and thickness of glass during a manufacturing process, and more particularly to a puddle formation device that controls the flow, temperature, and thickness of glasses having a low liquidus viscosity during the manufacturing process.

Flat glass has traditionally been manufactured using a float process or a down-draw fusion process. The fusion process proceeds with two flows of glass generated by controlled overflow around an isopipe made of refractory material. The two flows are kept in contact with the isopipe and then united at the bottom tip (root) of the isopipe to form a sheet of semisolid glass. The two faces of the sheet of glass never come in contact with any other surface, and therefore provide a sheet of pristine glass. Although the fusion process has made it possible to produce sheets of glass having exceptional surface quality (in terms of smoothness, thickness, and flatness or planarity), the fusion process cannot be used with all types of glass compositions.

The speed of travel for a sheet of glass is generally set with reference to pairs of edge wheels that act on the margins of the glass sheet. Once the glass sheet has cooled sufficiently to become solid, downstream from the isopipe, pull rollers are also generally used to keep the sheet of glass under tension and to stretch the sheet to a desired thickness. The glass flow is controllable if the flow of glass in contact the root of the isopipe is maintained at a high level of viscosity. If the viscosity is not sufficiently high, then gravity forces dominate the viscosity forces and tensioning the flow of semisolid glass leaving the bottom tip of the isopipe becomes impossible.

One skilled in the art would appreciate that a glass composition should have a viscosity greater than about 200,000 poise (P) to be usable in a traditional fusion process. Several glass compositions have a liquidus viscosity as high as 500 kP, which can provide a high viscosity at the root of the isopipe and a sufficiently high tension at the root. The tension at the root is a function of glass thickness and viscosity. A high root tension allows the manufacture of glass sheets with a thickness as high as 3 mm. Unfortunately, when glasses having a liquidus viscosity lower than about 200 kP come in contact with the isopipe, crystals can develop within the glass, which is incompatible with producing glass sheets of the desired quality. Thus, glass compositions having liquidus viscosities in the range of 1 kP would require the glass at the root of the isopipe to be maintained at viscosities lower that 1 kP, which significantly reduces the root tension. Such a reduction in root tension limits the maximum glass thickness that can be produced because the low root tension can result in defects (e.g., baggy warp).

In view of such technical problems, a conventional fusion process is unsuitable for producing sheets of excellent quality glass using glass compositions having a low liquidus viscosity. One process for making glass sheets from such glass compositions is disclosed in US 2004/0093900 (published May 20, 2004), the contents of which are incorporated by reference in its entirety. In that process, the semisolid glass flowing from an isopipe falls freely onto a single side roller located a short distance below the root of the isopipe. The thickness and temperature of the glass flowing onto the side roller are important for managing the average viscosity of the glass. For instance, as the thickness and average speed of the glass flowing from the landing location of the single side roller varies, the thickness profile of the glass leaving the side roller varies, resulting in thickness variations in the final glass sheet. The present disclosure provides an improvement to the apparatus and process described in US 2004/0093900 by controlling the thickness and flow of the glass on the side roller.

### SUMMARY

In one embodiment, an apparatus for manufacturing a glass sheet is provided. The apparatus can include a glass delivery device; a puddle forming device positioned below the glass delivery device, the puddle forming device oriented to contact and redirect at least a portion of a stream of molten glass as it falls from the glass delivery device. The side roller can be configured to rotate about a central axis and contact the stream falling from the glass delivery device and redirected from the puddle forming device at a target position and lose contact with the stream at a departure position to provide a ribbon of glass. The puddle forming device and the side roller are relatively positioned to form a puddle of molten glass on a surface of the side roller positioned upstream from the target position and a thickness control gap between the puddle forming device and the side roller. The stream of molten glass falling from the glass delivery device has a first thickness T1 that is greater than a second thickness T2 of the ribbon of glass falling from the side roller.

A further embodiment includes a method for manufacturing a glass sheet. The method can include the steps of flowing a stream of molten glass from a glass delivery device, contacting and redirecting at least a portion of the stream of molten glass with a puddle forming device positioned below the glass delivery device, receiving the stream falling from the glass delivery device and the portion of the stream redirected from the puddle forming device with a side roller at a target position and forming a glass ribbon from a departure position where the stream loses contact with and falls from the side roller, and forming a puddle of molten glass on a surface of the side roller at a position upstream from the target position and a thickness control gap between the puddle forming device and the side roller. The stream of molten glass falling from the glass delivery device has a first thickness T1 that is greater than a second thickness T2 of the ribbon of glass falling from the side roller.

Additional features and advantages of the embodiments disclosed herein will be set forth in the detailed description that follows, and in part will be clear to those skilled in the art from that description or recognized by practicing the embodiments described herein, including the detailed description which follows, the claims, as well as the appended drawings.

Both the foregoing general description and the following detailed description present embodiments intended to provide an overview or framework for understanding the nature and character of the embodiments disclosed herein. The accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

FIG. 1 (PRIOR ART) is a sectional view of a glass manufacturing apparatus for glass compositions having a liquidus viscosity lower than about 200 kP;

FIG. 2 is a sectional view of a glass forming apparatus with a puddle formation device, in accordance with embodiments herein; and

FIG. 3 is a sectional view of another glass forming apparatus with a puddle formation device, in accordance with embodiments herein.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure can be embodied in many different forms and should not be construed as limited to the embodiments set forth herein.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art.

Ranges can be expressed herein as from “about” one particular value, and/or to “about” another particular value. When such a range is expressed, another embodiment includes from the one particular value to the other particular value. Similarly, when values are expressed as approximations by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, above, below, right, left, front, back, top, bottom, laterally, longitudinally—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

The word “exemplary,” “example,” or various forms thereof are used herein to mean serving as an example, instance, or illustration. Any aspect or design described herein as “exemplary” or as an “example” should not be construed as preferred or advantageous over other aspects or designs. Furthermore, examples are provided solely for purposes of clarity and understanding and are not meant to limit or restrict the disclosed subject matter or relevant portions of this disclosure in any manner. It can be appreciated that a myriad of additional or alternate examples of varying scope could have been presented but have been omitted for purposes of brevity.

As used herein, the terms “comprising” and “including,” and variations thereof, shall be construed as synonymous and open-ended, unless otherwise indicated. A list of elements following the transitional phrases comprising or including is a non-exclusive list, such that elements in addition to those specifically recited in the list may also be present.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

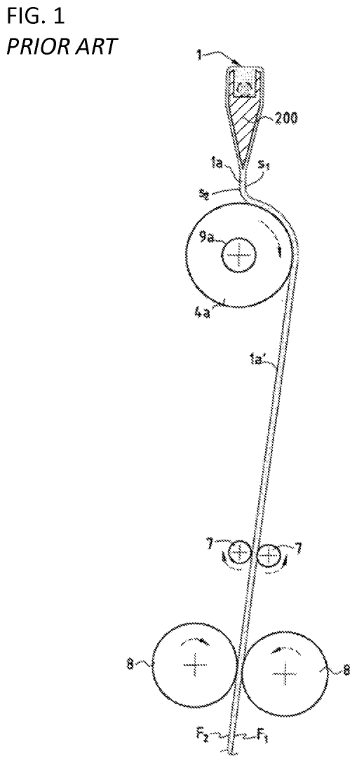

FIG. 1 is a sectional view of a prior art apparatus for manufacturing a glass sheet. The apparatus in FIG. 1 includes a glass delivery device (200) for providing a stream (1a) of molten glass from a mass thereof (1), a rotatable side roller (4a) having a position where the stream lands (near the “12 o'clock” position) and a position where the stream departs (near the “3 o'clock” position). The apparatus also includes a set of edge wheels (7) that act on the margins of the glass ribbon departing from the side roller (4a), and a set of pull rollers (8) downstream from the edge wheels (7), which act on the entire width of the glass ribbon. The prior art apparatus and process for making glass sheets are disclosed in US 2004/0093900 (published May 20, 2004), the contents of which are incorporated by reference in its entirety. Because the apparatus in FIG. 1 of the prior art has a single side roller (4a), all the molten glass from the delivery device (200) falls onto the side roller (4a). Therefore, any fluctuation in the glass flowing from the glass delivery device (200) can directly alter the thickness (T) of the glass departing from the side roller. Although the process includes a thickness tuning capability downstream of the side roller (e.g., pull rollers 8), any thickness variations in the glass flowing from the departure location of the side roller (4a) can result in variations in the local thickness profile of the final glass sheets.

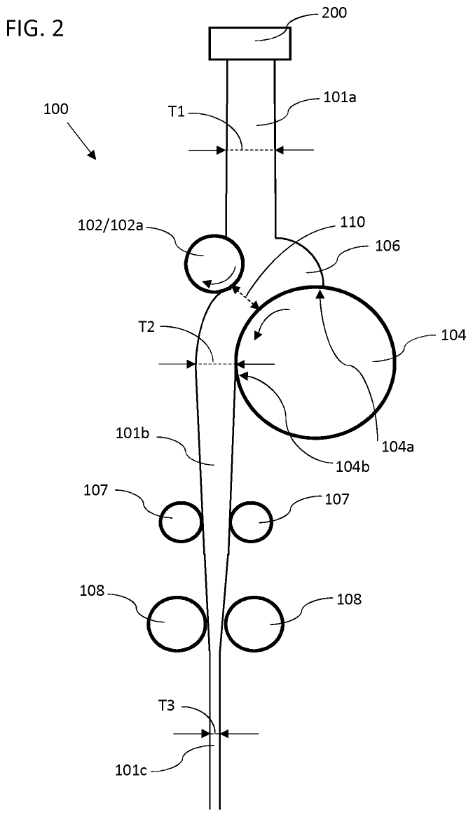

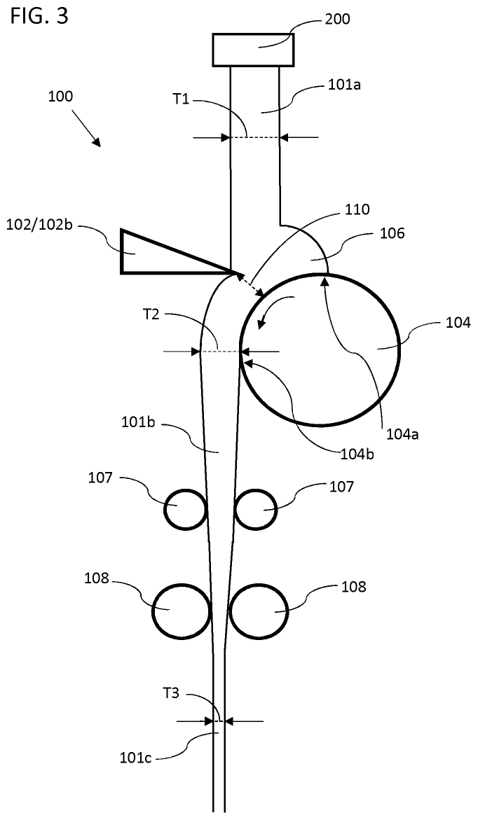

In various embodiments, as shown in FIGS. 2 and 3, the improved apparatus (100) and method for manufacturing a glass sheet disclosed herein include, among other things, a glass delivery device (200) for providing a stream of molten glass (101a), a side roller (104), and a puddle forming device (102). In some embodiments, a single side roller (104) is provided.

The glass delivery device (200) is not particularly limited. The stream of molten glass (101a) may be delivered using any suitable glass delivery method. For example, in some embodiments, the molten glass (101a) may be delivered in batches from a crucible or a pre-shaped ladle; or, the molten glass (101a) may be continuously fed to the forming rolls as a stream of glass from a fishtail orifice, slot orifice, fusion forming isopipe, an extrusion furnace, an inclined trough, etc.

In various embodiments, the side roller (104) has a cylindrical shape and is configured to rotate about a central axis thereof (i.e., the longitudinal axis of the roller). The side roller (104) rotates in a direction and at a speed to eliminate any relative movement between the roller and the stream of molten glass in contact with the roller. The side roller (104) is therefore used to mechanically stabilize the stream of molten glass (101a).

In some embodiments, the side roller (104) includes a temperature adjustment device adapted to maintain a consistent temperature on the surface of the side roller (104). For example, in some embodiments, the side roller (104) includes one or more internal recesses for the circulation of a cooling fluid (e.g., air or water). In such embodiments, the temperature of the side roller (104), including the surface, can be controlled so the stream (101a) can be cooled in a controlled manner to adjust the viscosity of the stream before it departs from the side roller (104) toward the edge wheels (107). During operation of the apparatus, the conduction cooling of the side roller (104) needs to be consistent to maintain the glass viscosity at the departure position, to maintain a consistent thickness, and to minimize the tension variation. In some embodiments, the temperature adjustment device comprises a heating element to control the temperature of the side roller (107), including the surface, can be controlled so the stream (101a) can be maintained a desired viscosity.

In some embodiments, the side roller (104) includes a target position (104a), where the stream (101a) falling from the glass delivery device (200) and the portion of stream redirected from the puddle forming device (102) are received by the side roller (104). In some embodiments, the side roller (104) includes a departure position (104b), where the stream loses contact with and falls from the side roller (104) to provide a ribbon of glass (101b). In some embodiments, the side roller (104) is configured to accompany the stream as it rotates from the target position (104a) to the departure position (104b), and the side roller (104) causes an increase in a viscosity of the stream such that the viscosity of the stream at the target position is lower than the viscosity of the stream at the departure position.

In various embodiments, the puddle forming device (102) is positioned downstream and below the glass delivery device (200), and at least partially upstream from the side roller (104). The distance (height) between the glass delivery device (200) and the puddle forming device (102), through which the stream of molten glass (101a) can fall, is naturally limited. The stream should be taken up before it becomes unstable. The acceptable fall height naturally depends on the glass composition, delivery viscosity, and flowrate. In some embodiments, the fall height can range from about 2 millimeters (mm) to about 150 mm, or from about 10 mm to about 100 mm, or about 50 mm to about 80 mm. The ranges include any combination of endpoints and intervening amounts. In such embodiments, the puddle forming device (102) is positioned and configured to contact and redirect at least a portion of the stream (101a) as it falls from the glass delivery device (200). In such embodiments, the puddle forming device (102) and the side roller (104) are relatively positioned to produce a thickness control gap (110) therebetween. In such embodiments, a puddle (106) of excess molten glass accumulates on a surface of the side roller (104). In such embodiments, the puddle (106) is located upstream from both the target position (104a) on the side roller (104) and the thickness control gap (110) between the side roller and the puddle forming device (102). In some embodiments, the thickness control gap (110) is determined to avoid an excess size of puddle (106). In some embodiments, a feedback control between the thickness control gap (110) and the size of the puddle (106) (or temperature at the departure location of the glass) can be used to manage the setpoint of the thickness control gap (110).

Due to the positioning of the puddle forming device (102) and the side roller (104) with respect to the glass delivery device (200), the apparatus (100) can rely on gravity to pull the stream of molten glass (101a) down from the delivery device (200) toward the puddle forming device (102) and the side roller (104). In some embodiments, the rate of the molten glass flowing from the delivery device (200) is controlled. In some embodiments, the thickness control gap (110) between the side roller (104) and the puddle forming device (102) result in the formation of a puddle (106) on the surface of the side roller (104). In such embodiments, the puddle (106) enables a controlled flow rate on the side roller (104). In other words, maintaining a puddle (106) upstream from the thickness control gap (110) while the side roller (104) is rotating results in a consistent glass flow. In such embodiments, the side roller (104) drives at a constant speed, which can result in a consistent temperature and the desired viscosity. In such embodiments, the rotational speed of the side roller (104) is independent of the rate of the molten glass flowing from the delivery device (200). Additionally, in some embodiments, the rotational speed of the side roller (104) is independent from the components used downfield to tune the thickness of the glass ribbon (e.g., edge wheels, pull rollers).

In some embodiments, the location and positioning of the puddle forming device (102) is adjustable. For example, in some embodiments, the puddle forming device (102) is positioned below the glass delivery device and can be repositioned laterally, longitudinally, and/or tangentially with respect to the side roller (104). Adjusting the location and positioning of the puddle forming device (102) with respect to its distance from the side roller (104) makes the size of the thickness control gap (110) adjustable and controllable. In such embodiments, the adjustable distance between the side roller (104) and the puddle forming device (102) provides an adjustable length of the thickness control gap (110).

In some embodiments, the puddle forming device (102) includes a temperature adjustment device adapted to maintain a consistent temperature on the surface of the puddle forming device (102). In such embodiments, the temperature of the puddle forming device (102) can be adjusted as needed to avoid the nucleation of crystals in the mass of molten glass. For example, in some embodiments, the puddle forming device (102) includes one or more internal recesses for the circulation of a cooling fluid (e.g., air or water). In some embodiments, the puddle forming device (102) includes a heating element. Thus, in such embodiments, the temperature of the puddle forming device (102), including the surface, can be controlled so the stream (101a) can be cooled or warmed in a controlled manner to adjust the viscosity of the stream before it departs from the puddle forming device (102) toward the side roller (104) and/or the edge wheels (107). During operation of the apparatus, the conduction cooling or heating of the puddle forming device (102) needs to be consistent enough to maintain the glass at a desired viscosity.

In some embodiments, as shown in FIG. 2, the puddle forming device (102) is a puddle forming roller (102a). In such embodiments, the puddle forming roller (102a) is located upstream from the side roller (104). In some embodiments, the puddle forming roller (102a) is idle or driven, depending on the drag. For example, if the stream has a sufficient resistance to rotate the puddle forming roller (102a), the roller can be an idle roll; or, if the stream does not have a sufficient resistance to rotate the puddle forming roller (102a), then it is driven by a motor. The puddle forming roller (102a), in some embodiments, has a cylindrical shape and is configured to rotate about a central axis thereof (i.e., the longitudinal axis of the roller). In some embodiments, the puddle forming roller (102a) and the side roller (104) are positioned on opposing sides of the stream (101a) and rotate about their respective central axes in opposite directions. For example, in some embodiments, the puddle forming roller (102a) rotates counterclockwise and the sider roller (104) rotates clockwise; and in some embodiments, the puddle forming roller (102a) rotates clockwise and the side roller (104) rotates counterclockwise. In some embodiments, the puddle forming roller (102a) rotates at a speed equal to or greater than the rotational speed of the side roller (104), depending on temperature/viscosity gradient between puddle forming roller (102a) and the side roller (104). In addition, the constant thickness of glass flow leaving the side roller (104) allows for the side roller (104) to run at a constant velocity independent of set of edge wheels (107) and pull rollers (108).

In some embodiments, as shown in FIG. 3, the puddle forming device (102) is a puddle forming gate (102b). In such embodiments, the puddle forming gate (102b) is located upstream from the side roller (104). Similar to the puddle forming roller (102a), the puddle forming gate (102b) can force the stream of molten glass (101a) leaving the side roller (104) into a consistent thickness. The puddle forming gate (102b) can be any suitable size and shape. In some embodiments, for example, the puddle forming gate (102b) has a wedge-shape, rectangular-shape, or another shape suitable for directing the stream of molten glass (101a) toward the side roller (104).

In some embodiments, the puddle forming roller (102a) or puddle forming gate (102b) includes a temperature adjustment device adapted to maintain a consistent temperature on the surface of the puddle forming roller/gate (102a, 102b). In such embodiments, the temperature of the puddle forming roller/gate (102a, 102b) can be adjusted as needed to avoid the nucleation of crystals in the mass of molten glass. For example, in some embodiments, the puddle forming roller/gate (102a, 102b) includes one or more internal recesses for the circulation of a cooling fluid (e.g., air or water). In some embodiments, the puddle forming roller/gate (102a, 102b) includes a heating element. Thus, in such embodiments, the temperature of the puddle forming roller/gate (102a, 102b), including the surface, can be controlled so the stream (101a) can be cooled or warmed in a controlled manner to adjust the viscosity of the stream before it departs from the puddle forming roller/gate (102a, 102b) toward the side roller (104) and/or the edge wheels (107). During operation of the apparatus, the conduction cooling or heating of the puddle forming roller/gate (102a, 102b) needs to be consistent enough to maintain the glass at a desired viscosity.

In some embodiments, the location and positioning of the puddle forming roller (102a) or puddle forming gate (102b) is adjustable. For example, in some embodiments, the puddle forming roller/gate (102a, 102b) is positioned below the glass delivery device and can be repositioned laterally, longitudinally, and/or tangentially with respect to the side roller (104). Adjusting the location and positioning of the puddle forming roller/gate (102a, 102b) with respect to its distance from the side roller (104) makes the size of the thickness control gap (110) adjustable and controllable. In such embodiments, the adjustable distance between the side roller (104) and the puddle forming roller/gate (102a, 102b) provides an adjustable length of the thickness control gap (110).

In some embodiments, the apparatus (100) includes a set of edge wheels (107) positioned downstream from the side roller (104) and configured to receive the ribbon of glass (101b) flowing from the side roller (104). In some embodiments, the edge wheels (107) exclusively act on the margins (i.e., outer edges) of the glass ribbon (101b). In such embodiments, the margins can be subsequently removed and excluded from the final glass product. In some embodiments, the apparatus (100) includes a set of pull rollers (108) positioned downstream from the set of edge wheels (107). In some embodiments, the pull rollers (108) act on the entire width of the glass ribbon (101b). In some embodiments, the pull rollers (108) are configured to stretch the ribbon of glass (101b) to a desired thickness for the final glass product. In such embodiments, the pull rollers (108) provide a downstream thickness tuning capability.

In various embodiments, as shown in FIGS. 2 and 3, an improved apparatus and method for manufacturing a glass sheet are provided. In some embodiments, the improved apparatus and method are particularly useful for glass compositions having a liquidus viscosity value that is lower than about 200 kP, or lower than about 100 kP, or lower than about 1 kP. In some embodiments, the glass compositions has a liquidus viscosity value in the range of about 1 kP to about 200 kP, or from about 1 kP to about 100 kP. In some embodiments, the addition of the puddle formation device (102) provides superior control over the liquidus viscosity of the glass particularly flowing on the surface of and departing from the side roller (104).

In some embodiments, the stream of molten glass (101a) falling from the glass delivery device (200) toward the target position (104a) has a temperature in the range of about 1,000° C. or higher, and a liquidus viscosity in the range of about 100 P to about 50 kP. In some embodiments, the glass flowing on to the surface of the side roller (104) has a temperature in the range of about 700° C. to about 1,400° C., and a viscosity in the range of about 1 kP to about 200 kP, or from about 1 kP to about 100 kP, or from about 100 kPs to about 200 kPs. In some embodiments, the ribbon of glass (101b) flowing from the departure position (104b) of the side roller (104) comprises a temperature in the range of about 1,000° C. or lower, and a liquidus viscosity of about 300 kP.

The improved apparatus and method for manufacturing a glass sheet disclosed herein provides excellent control over the thickness, temperature, and viscosity of the glass flowing to and from the side roller (104). In some embodiments, the addition of the puddle formation device (102) provides superior control over the thickness of the glass flowing on the surface of the side roller (104). In some embodiments, the stream of molten glass (101a) falling from the glass delivery device (200) has a first thickness (T1) and the ribbon of glass (101b) departing from the side roller (104) has a second thickness (T2). In such embodiments, (T1) is greater than (T2). In some embodiments, the second thickness (T2) is equal to or less than the thickness control gap (110). In some embodiments, the glass ribbon (101c) obtained downstream from the set of edge wheels (107) and the set of pull rollers (108) has a third thickness (T3). In such embodiments, (T2) is greater than (T3). Accordingly, in some embodiments, the puddle formation device provides superior control over the thickness the glass sheet.

In some embodiments, the method for manufacturing a glass sheet comprises the steps of providing a stream of molten glass (101a) from a glass delivery device (200); and contacting the stream of molten glass (101a) with a puddle forming device (102) positioned under the glass delivery device (200) in order to redirect at least a portion of the stream as it falls from the glass delivery device (200). In some embodiments, the method comprises the steps of rolling the stream falling from the glass delivery device (101a) and the portion of the stream redirected from the puddle forming device (102) with a single side roller (104) having a target position (104a) where the stream is received and a departure position (104b) where the stream loses contact with and falls from the side roller (104) to provide a ribbon of glass. In some embodiments, the method includes forming a thickness control gap (110) between the puddle forming device (102) and the side roller (104), forming a puddle of molten glass (106) on a surface of the side roller (104) at a position upstream from the target position (104a) and the thickness control gap (110). In some embodiments, the method includes forming a ribbon of glass (101b) as the stream (101a) and the puddle (106) of molten glass are accompanied by the surface of the side roller (104). In such embodiments, the stream of molten glass (101a) falling from the glass delivery device (200) has a first thickness (T1), the ribbon of glass (101b) falling from the side roller (104) has a second thickness (T2), and (T1) is greater than (T2). In some embodiments, the method comprises providing a set of edge wheels (107) positioned downstream from the side roller (104) and configured to receive the margins of the ribbon of glass (101b) falling from the side roller (104), and a set of pull rollers (108) positioned downstream from the set of edge wheels (107) and configured to stretch the ribbon of glass to a desired third thickness (T3) (101c). In such embodiments, (T2) is greater than (T3).

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. An apparatus for manufacturing a glass sheet, comprising:
a glass delivery device;
a puddle forming device positioned below the glass delivery device, the puddle forming device oriented to contact and redirect at least a portion of a stream of molten glass as it falls from the glass delivery device; and
a side roller configured to rotate about a central axis and contact the stream falling from the glass delivery device and redirected from the puddle forming device at a target position and lose contact with the stream at a departure position to provide a ribbon of glass;
wherein the puddle forming device and the side roller are relatively positioned to form a puddle of molten glass on a surface of the side roller positioned upstream from the target position and a thickness control gap between the puddle forming device and the side roller, and
wherein the stream of molten glass falling from the glass delivery device has a first thickness T1 that is greater than a second thickness T2 of the ribbon of glass falling from the side roller.

2. The apparatus according to claim 1, further comprising a set of edge wheels positioned downstream from the side roller and configured to receive the ribbon of glass falling from the side roller, and a set of pull rollers positioned downstream from the set of edge wheels and configured to stretch the ribbon of glass to a desired third thickness T3, wherein T2 is greater than T3.

3. The apparatus according to claim 1, wherein the puddle forming device comprises a puddle forming roller configured to rotate about a central axis thereof,
wherein the puddle forming roller and the side roller rotate about their respective central axes in opposite directions, and
wherein the puddle forming roller rotates at a speed equal to or greater than the side roller rotation speed.

4. The apparatus according to claim 1, wherein the puddle forming device comprises a wedge shaped gate.

5. The apparatus according to claim 1, wherein the puddle forming device can be repositioned laterally, longitudinally, and/or tangentially with respect to the side roller to adjust a dimension of the thickness control gap.

6. The apparatus according to claim 1, wherein the side roller and/or puddle forming device comprises a temperature adjustment device adapted to maintain a consistent temperature on the surface of the side roller and/or puddle forming device, respectively.

7. The apparatus according to claim 1, wherein the stream of molten glass falling from the glass delivery device comprises a temperature of about 1,000° C. or higher, and a liquidus viscosity of about 200 kP or less.

8. The apparatus according to claim 1, wherein the ribbon of glass falling from the departure position of the side roller comprises a temperature of about 1,000° C. or less, and a liquidus viscosity of about 200 kP or more.

9. The apparatus according to claim 1, wherein the side roller is configured to accompany the stream as it rotates from the target position to the departure position,
wherein the side roller causes an increase in a viscosity of the stream such that the viscosity of the stream at the target position is lower than the liquidus viscosity of the stream at the departure position.

10. The apparatus according to claim 1, wherein the glass feeding device comprises a fishtail orifice, slot orifice, fusion forming isopipe, or an extrusion furnace.

11. A method for manufacturing a glass sheet, comprising:
flowing a stream of molten glass from a glass delivery device;
contacting and redirecting at least a portion of the stream of molten glass with a puddle forming device positioned below the glass delivery device;
receiving the stream falling from the glass delivery device and the portion of the stream redirected from the puddle forming device with a side roller at a target position and forming a glass ribbon from a departure position where the stream loses contact with and falls from the side roller; and
forming a puddle of molten glass on a surface of the side roller at a position upstream from the target position and a thickness control gap between the puddle forming device and the side roller;
wherein the stream of molten glass falling from the glass delivery device has a first thickness T1 that is greater than a second thickness T2 of the ribbon of glass falling from the side roller.

12. The method according to claim 11, further comprising:
receiving the ribbon of glass falling from the side roller with a set of edge wheels positioned downstream from the side roller, and stretching the ribbon of glass to a desired third thickness T3 with a set of pull rollers positioned downstream from the set of edge wheels, wherein T2 is greater than T3.

13. The method according to claim 11, wherein the puddle forming device comprises a puddle forming roller rotating about a central axis thereof and the side roller rotates about a central axis thereof,
wherein the puddle forming roller and the side roller rotate about their respective central axis in opposite directions, and
wherein the puddle forming roller rotates at a speed equal to or greater than the side roller rotation speed.

14. The method according to claim 11, wherein the puddle forming device comprises an acyclic shaped gate.

15. The method according to claim 11, wherein the puddle forming device can be repositioned laterally, longitudinally, and/or tangentially with respect to the side roller to adjust a dimension of the thickness control gap.

16. The method according to claim 11, wherein the side roller and/or puddle forming device comprises a temperature adjustment device adapted to maintain a consistent temperature on the surface of the side roller and/or puddle forming device, respectively.

17. The method according to claim 11, wherein the stream of molten glass falling from the glass delivery device comprises a temperature of about 1,000° C. or higher, and a liquidus viscosity of about 200 kP or less.

18. The method according to claim 11, wherein the ribbon of glass falling from the departure position of the side roller comprises a temperature of about 1,000° C. or less, and a liquidus viscosity of about 200 kP or more.

19. The method according to claim 11, wherein the side roller accompanies the stream as it rotates from the target position to the departure position,
wherein the side roller causes an increase in a viscosity of the stream such that the viscosity of the stream at the target position is lower than the viscosity of the stream at the departure position.

20. The method according to claim 11, wherein the glass feeding device comprises a fishtail orifice, slot orifice, fusion forming isopipe, or an extrusion furnace.
